(19) United States
(12) Patent Application Publication
(10) Pub. No.: US 2010/0201865 A1
(43) Pub. Date: Aug. 12, 2010

(54) IMAGING METHOD FOR USE WITH VARIABLE CODED APERTURE DEVICE AND IMAGING APPARATUS USING THE IMAGING METHOD

(75) Inventors: Hee-chul HAN, Hwaseong-si (KR); Hyun-seok HONG, Suwon-si (KR); Seung-ki CHO, Suwon-si (KR); Jae-moon JO, Seongnam-si (KR); Sahng-gyu PARK, Seongnam-si (KR); Byung-sun CHOI, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/683,773

(22) Filed: Jan. 7, 2010

(30) Foreign Application Priority Data
Feb. 9, 2009 (KR) 10-2009-0010212

(51) Int. Cl. H04N 5/235; H04N 5/228

(52) U.S. Cl. 348/362; 348/222.1; 348/E05.034

(57) ABSTRACT

Provided are an imaging method for use with a variable coded aperture filter and an imaging apparatus using the imaging method. The variable coded aperture filter includes a plurality of regulated patterns which may be properly selected, and an image obtained via a certain pattern of the variable coded aperture filter may be processed by a deconvolution method related to the certain pattern. The patterns in the variable coded aperture filter have different aperture degrees from each other so as to adjust an exposure amount, and accordingly, a subject which is extremely bright or extremely dark may be photographed and depth information and focus information may be obtained from the photographed image. Therefore, images of high image quality may be obtained in a large range of brightness variation.

### CROSS-REFERENCE TO RELATED PATENT APPLICATIONS

This application claims priority from Korean Patent Application No. 10-2009-0010212, filed on Feb. 9, 2009, and all the benefits accruing therefrom under 35 U.S.C. §119, the contents of which are incorporated herein by reference in their entirety.

### BACKGROUND

1. Field of the Invention

Apparatuses and methods consistent with the present invention relate to an imaging method using coded aperture and an apparatus using the imaging method.

2. Related Art

Imaging apparatuses such as digital cameras may use a deconvolution method for image processing. Deconvolution is a technique for recovering an image which is out of focus into an image that is well-focused, and accordingly, requires a method of predicting a point spread function (PSF). Using this method, Anat Levin et al. of Massachusetts Institute of Technology (MIT) has separated an image including subjects in different focuses, and realized an all in-focus image in which all subjects in the image are in-focus. According to this method, a convolution image is obtained from another image using a coded aperture filter designed to distinguish a difference between subjects in different focuses from each other, and then, a well-focused image is obtained by performing a deconvolution with respect to the convolution image. However, in the case of an imaging apparatus using a coded aperture filter, an intensity of incident light is inevitably reduced due to the coded aperture filter and precise depth information and focus information cannot be obtained from an image taken under extremely low or extremely high illumination conditions. Thus, in order to obtain images of high image quality via deconvolution in the imaging method using a coded aperture filter, precise depth information and focus information for a large range of illumination conditions have been necessary.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Exemplary embodiments of the present invention provide an imaging method whereby image information such as depth and/or focus information that are required to perform a deconvolution process may be obtained from a subject under a large range of brightness conditions, and an imaging apparatus using the imaging method.

According to an exemplary embodiment of the present invention, there is provided an imaging method including: obtaining a convolution image of a subject by using a variable coded aperture filter including a coded pattern selected from among a plurality of coded patterns; and processing the convolution image using a deconvolution method corresponding to the selected coded pattern from among a plurality of deconvolution methods respectively corresponding to the plurality of coded patterns.

According to another exemplary embodiment of the present invention, there is provided an imaging apparatus including: a light receiving device; a lens device disposed in an optical path of a light proceeding toward the light receiving device; a variable coded aperture filter controlling the light incident onto the light receiving device and modulating the light using a plurality of coded patterns; and an image processor having deconvolution logic structures corresponding to each of coded patterns of the variable coded aperture filter for performing a deconvolution of an image output from the light receiving device.

The plurality of coded patterns may have different aperture degrees from each other.

The variable coded aperture filter may be a liquid crystal (LC) optical shutter filter, a micromirror array including a plurality of movable mirrors, or a mechanical iris including a plurality of diaphragms.

The variable coded aperture filter may include an LC optical controller controlling lights corresponding to a plurality of coded patterns.

The variable coded aperture filter may include a micromirror optical controller including a plurality of movable mirrors, which modulates the light corresponding to the plurality of coded patterns and reflects the light to the light receiving device.

The variable coded aperture filter may include a mechanical iris including a plurality of diaphragms which are disposed on a proceeding path of the light to adjust the area of the region through which the light passes, each of the diaphragms may include a light through hole corresponding to each of the plurality of coded patterns, and the light may be modulated by the light through hole to correspond to the plurality of coded patterns.

### BRIEF DESCRIPTION OF THE DRAWINGS

The above and other aspects of the present invention will become more apparent by describing in detail exemplary embodiments thereof with reference to the attached drawings in which:

FIG. 1 is a diagram of a digital single lens reflex (DSLR) camera, which is an example of an imaging apparatus according to an exemplary embodiment of the present invention;

FIG. 2 is a flowchart of an imaging method according to an exemplary embodiment of the present invention;

FIGS. 3A through 3D are diagrams showing various patterns of a variable coded filter according to exemplary embodiments of the present invention;

FIG. 4 is a diagram of an LC optical shutter used as a variable coded filter according to an exemplary embodiment of the present invention;

FIG. 5 is a diagram of a mechanical iris used as a variable coded filter according to another exemplary embodiment of the present invention;

FIG. 6 is a diagram of a micro-mirror array used as a variable coded filter according to another exemplary embodiment of the present invention;

FIG. 7 is a diagram showing a DSLR camera, which is an example of an imaging apparatus according to another exemplary embodiment of the present invention; and

FIG. 8 is a diagram showing a DSLR camera, which is an example of an imaging apparatus according to another exemplary embodiment of the present invention.

### DETAILED DESCRIPTION OF EXEMPLARY EMBODIMENTS OF THE INVENTION

The exemplary embodiments are described more fully hereinafter with reference to the accompanying drawings, in which exemplary embodiments are shown. This should not be construed as limiting the claims to the exemplary embodiments shown. Rather, these exemplary embodiments are provided to convey the scope of the invention to those skilled in the art. In the drawings, the size and relative sizes of elements and regions may be exaggerated for clarity.

It will be understood that when an element or layer is referred to as being “on”, “disposed on”, “disposed”, or “between” another element or layer, it can be directly on, disposed on, disposed, or between the other element or layer, or intervening elements or layers can be present.

The terms “first,” “second,” and the like, “primary,” “secondary,” and the like, as used herein do not denote any order, quantity, or importance, but rather are used to distinguish one element, region, component, layer, or section from another. The terms “front”, “back”, “bottom”, and/or “top” are used herein, unless otherwise noted, merely for convenience of description, and are not limited to any one position or spatial orientation.

The terms “a” and “an” do not denote a limitation of quantity, but rather denote the presence of at least one of the referenced item. The suffix “(s)” as used herein is intended to include both the singular and the plural of the term that it modifies, thereby comprising one or more of that term (e.g., the layer(s) includes one or more layers).

Reference throughout the specification to an “exemplary embodiment”, and so forth, means that a particular element (e.g., feature, structure, and/or characteristic) described in connection with the exemplary embodiment is included in at least one exemplary embodiment described herein, and may or may not be present in other exemplary embodiments. In addition, it is to be understood that the described elements may be combined in any suitable manner in the various exemplary embodiments.

Unless defined otherwise, technical and scientific terms used herein have the same meaning as is commonly understood by one of skill in the art to which this invention belongs.

An imaging method and an imaging apparatus according to exemplary embodiments of the present invention will be described with reference to accompanying drawings.

Exemplary embodiments of the present invention refer to a deconvolution method which may be used with a coded aperture device as suggested by Anat Levin et al.

A convolution image obtained by using a coded aperture device (filter) may have different frequencies by regions according to coding of the coded aperture device (filter). An image obtained by using a general imaging method includes zeros overlapping each other in the frequency domain, and accordingly, it is difficult to reconstruct or recover the image signal. However, in the image obtained by using the coded aperture device (filter), zeros are dispersed in the frequency domain. Thus, since the zeros are dispersed in the frequency domain, the image may be recovered and reconstructed.

However, in the above deconvolution method for the related art coded aperture device (filter), the coded aperture device (filter) has a fixed opening degree, and a light amount received by a light receiving device, that is, an exposure amount, may be adjusted by adjusting the exposure time. This method is different from a method used in a related art camera in which an exposure amount is adjusted via a diaphragm and exposure time. Therefore, in the related art imaging method for the coded aperture device (filter), the coded aperture device (filter) has a fixed aperture degree, and accordingly, an appropriate exposure may be obtained only by adjusting the light receiving time. However, under extremely high illumination conditions where the exposure time may not be adjusted via the light receiving time, an excessively exposed image may be obtained. Also, under low illumination conditions, information required to recover the image may not be obtained due to a lack of sufficient exposure.

Exemplary embodiments of the present invention provide an imaging method whereby an aperture may be adjusted using a deconvolution method for a coded aperture device (filter).

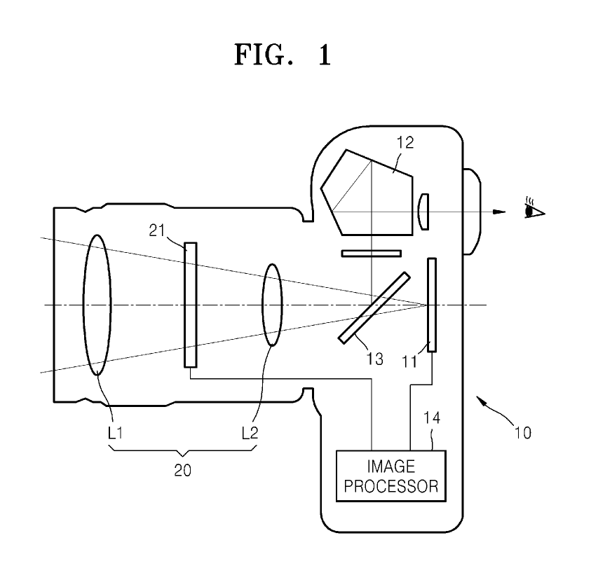

FIG. 1 shows a schematic structure of a DSLR camera according to an exemplary embodiment of the present invention. The DSLR camera is an exemplary embodiment of an imaging apparatus. A main body 10 of the DSLR camera includes a light receiving device 11, a pentaprism 12, a mirror 13, and an image processor 14. A lens mount 20 which is mounted in a front portion of the main body 10 includes a plurality of lenses L1 and L2 and a variable coded filter (aperture) 21.

The variable coded filter 21 filters incident light bouncing off a subject, and allows the light to pass through regions of a predetermined pattern designed to have a coded filter structure. The pattern is based on a design of the coded aperture filter according to an uncertain probabilistic model, which is a probabilistic model of real images. The coded aperture filter is coded so as to be sensitive to change in a depth of field. Therefore, the incident light bouncing off the subject is focused on the light receiving device 11 while being modified by a predetermined code when passing through the variable coded filter 21. A convolution image signal obtained from the light receiving device 11 is deblurred based on depth information and focus information of a convolution image obtained by the image processor 14. A deblurring or a deconvolution is a process of reconstructing the original sharp image by removing blur from the convolution image using a blur scale obtained from the above process.

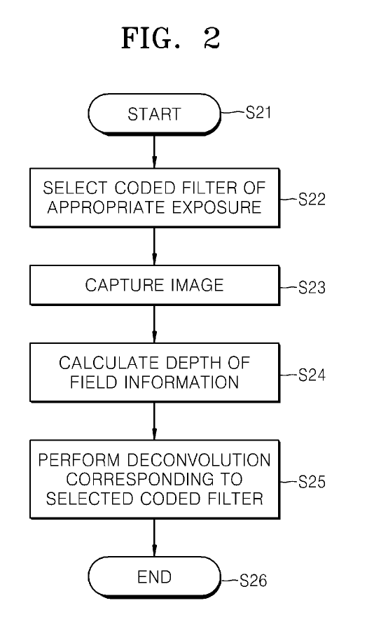

According to an exemplary embodiment of the present invention, a plurality of patterns according to the coded filter structure are provided in consideration of the exposure limitation, which occurs in the imaging method using one coded aperture. FIG. 2 is a flowchart of an imaging method according to an exemplary embodiment of the present invention. After initializing an imaging apparatus (operation S21) in order to start an image capturing (imaging) operation, a coded aperture filter having an appropriate aperture degree which corresponds to a brightness of the subject or peripheral illumination is selected (operation S22). After selecting the appropriate coded aperture filter, a shutter of the imaging apparatus is operated to obtain a convolution image (data) from the light receiving device (operation S23). The depth information and/or the focus information of the subject are obtained from the convolution image through the above described process (operation S24). Then, the deconvolution process which includes the deblurring process, in which blur of the convolution image is removed using the depth information and the focus information, is performed to obtain a deconvolution image (operation S25), and then the process ends (operation S26).

The variable coded filter 21 of exemplary embodiments of the present invention includes a plurality of coded patterns, each of which having a different aperture degree s to differentiate an intensity of light passing therethrough from other intensities of passing through other patterns. In addition, the image processor 14, which calculates the depth information and reconstructs the convolution image based on the depth information, has a logical structure for measuring a plurality of blur scales corresponding respectively to the plurality of patterns. For example, the coded patterns the variable coded filter 21 of exemplary embodiments of the present invention may correspond to f values representing an aperture amount of the lens in the imaging apparatus, for example, f=1.4, 2.0, 2.8, 4.0, 5.0, 8, 11, 16, and 22. That is, the imaging apparatus of exemplary embodiments of the present invention includes the variable coded aperture 21 which may adjust the exposure amount in multi-stages.

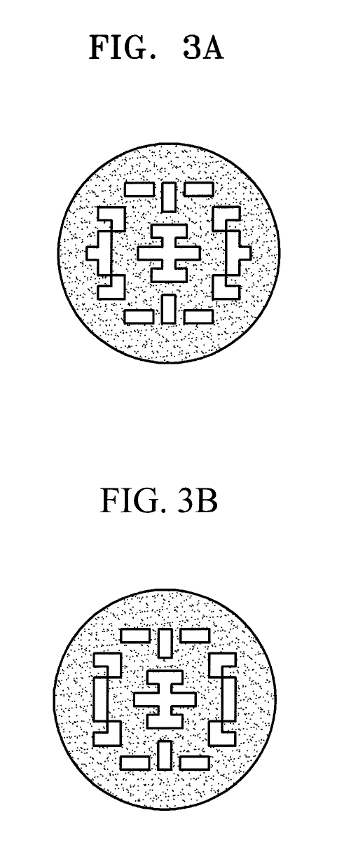

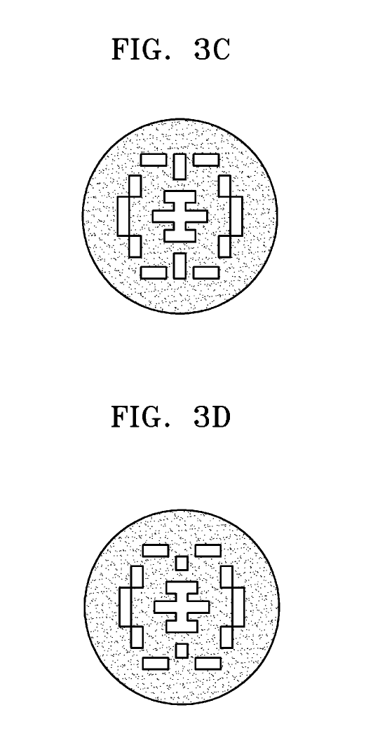

FIGS. 3A through 3D show examples of patterns having different aperture degrees in the variable coded filter 21. The patterns shown in FIGS. 3A through 3D exemplarily show the change in the aperture degrees, and accordingly, the coded pattern is changed according to the decrease of the aperture degree. When the aperture degrees of the coded patterns shown in FIGS. 3A through 3D change by one stop, the variable coded filter 21 may perform similarly to a diaphragm of the related art camera.

When the above variable coded filter 21 is used, the coded pattern having an appropriate aperture degree may be selected according to the brightness of the subject, and accordingly, an image of high quality may be captured within a greater range of brightness variation than in the case of using the related art imaging apparatus. The capturing of an image having high image quality allows sufficient blur scales to be extracted from the convolution image, and accordingly, the deblurring or the deconvolution may be performed successfully. Therefore, the original sharp image may be recovered or reconstructed.

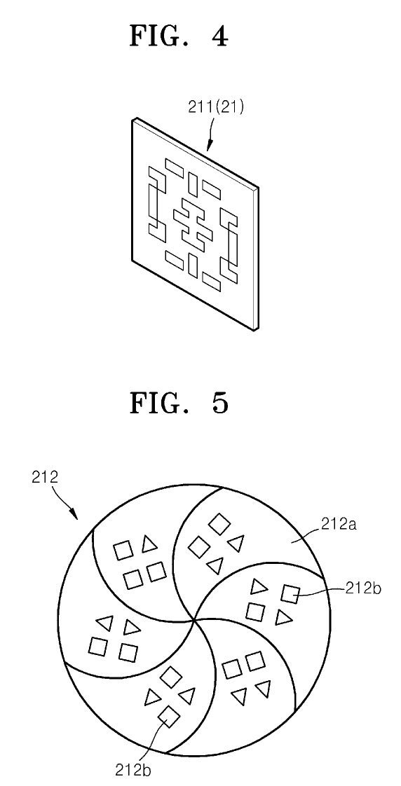

The variable coded filter 21 may be realized in various ways. For example, as shown in FIG. 4, a transmissive LC optical shutter 211 which may electro-optically control transmission of light may be used as the variable coded filter 21. The LC optical shutter 211 determines the transmission of light according to a change in optical characteristics of a liquid crystal such as in the case of related liquid crystal display (LCD) devices. Therefore, the transmission of light may be controlled by the coded patterns shown in FIGS. 3A through 3D, and accordingly, a brightness of the subject, that is, a light transmission intensity, may be adjusted.

Referring to FIG. 5, a mechanical diaphragm filter 212 having an iris structure including a plurality of diaphragms may be used as the variable coded filter 21. The diaphragm filter 212 includes a plurality of diaphragms 212a which surround an optical axis of incident light, and the diaphragms 212a control the intensity of transmitted light. In an exemplary embodiment of the present invention, each of the diaphragms 212a includes a plurality of penetration holes 212b having unit patterns for transmitting the light, and the variable coded pattern is formed by a group of the penetration holes 212b having unit patterns. Therefore, each of the diaphragms 212a includes the plurality of penetration holes 212b, and accordingly, the variable coded pattern may be formed at appropriate positions of the diaphragms 212a. FIG. 5 exemplarily shows the penetration holes 212b for forming the patterns of the variable coded filter 21, however, exemplary embodiments are not limited to the example shown.

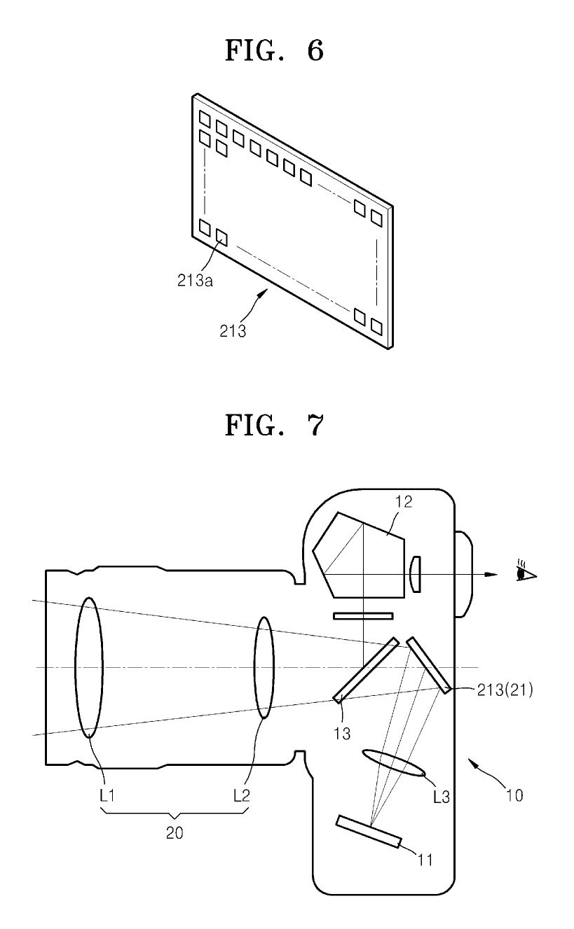

On the other hand, a micro mirror array 213 which has a predetermined pattern for reflecting light may be used as the variable coded filter 21 as shown in FIG. 6. A digital micromirror device (DMD) which is widely used in digital light processing (DLP) projectors is an example of the micro mirror array 213. In the DMD, an incident light is modulated by using a micro mirror having a microelectromechanical systems (MEMS) structure which drives a pixel unit to display desired image on a screen. The micromirror array 213 used as the variable coded filter 21 includes a plurality of micro driving mirrors 213a. The micro driving mirrors 213a are operated according to various patterns of the variable coded filter 21 to adjust the intensity of transmitted light and focus an image which is modulated to a predetermined code on the light receiving device 11.

FIG. 7 is a schematic diagram showing a DSLR camera using the micromirror array 213 shown in FIG. 6 as the variable coded filter 21.

The main body 10 includes the light receiving device 11, the pentaprism 12, the mirror 13, and the micromirror array 213. Furthermore, an image processor (not shown) may also be included. In addition, the lens mount 20 mounted in the front portion of the main body 10 includes a plurality of lenses L1 and L2.

In the main body 10, the micromirror array 213 is located on a rear portion of the mirror 13 to reflect the modulated light downward of the main body 10, and the light receiving device 11 is disposed at a position where the modulated light reflected by the micromirror array 213 is focused.

The light passing through the lens mount 20 is incident onto an area of the micromirror array 213, reflected by the micromirror array 213, and converged to be focused on the light receiving device 11. A lens L3 located in front of the light receiving device 11 is a sensing lens for converging the modulated light reflected from the micromirror array 213, and may be optional according to the optical design of the DSLR camera.

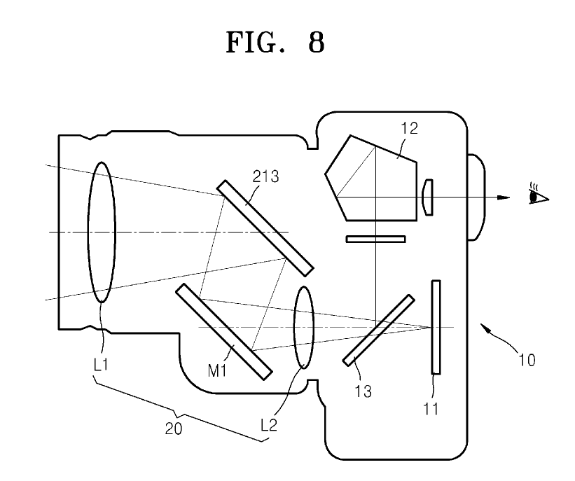

FIG. 8 is a schematic diagram of another example of a DSLR camera including the micromirror array 213 illustrated in FIG. 6.

The micromirror array 213 is located on a side of the lens mount 20. That is, the lens mount 20 includes a plurality of lenses L1 and L2 which are located on both sides of an optical path of light which is refracted twice. In addition, the micromirror array 213 is located on the first refracted portion between the lenses L1 and L2, and a fixed reflecting mirror M1 is located at the second refracted portion. The light passing through the lens L2 of the lens mount 20 is focused on the light receiving device 11 which is located on a rear portion of the mirror 13.

The imaging method of exemplary embodiments of the present invention excludes use of an auto-focusing mechanism which is traditionally used in related art cameras. Although the imaging method is not used in conjunction with a unit for forcedly focusing light on a light receiving device, a contrast detection system may be used, except in a case of an auto-focusing method using an astigmatic method. As known in the art, a contrast detection system may calculate the contrast of a certain portion of an image (mainly, a center portion of the image) while moving the lens, and determines that the image is in-focus when the contrast is the highest.

According to exemplary embodiments of the present invention, the plurality of coded patterns having different aperture degrees from each other are formed in a variable coded filter, and accordingly, the depth information and the focus information which are required to perform the deconvolution process may be obtained from the image including the subject under extremely bright or dark conditions. Therefore, images of high image quality may be obtained without using an auto-focusing device which is complex and expensive.

The imaging apparatus may also be used in a video camera in addition to the DSLR camera, and may be modified to various ways. While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An imaging method comprising:
obtaining a convolution image of a subject by using a variable coded aperture filter including a coded pattern selected from among a plurality of coded patterns; and
processing the convolution image using a deconvolution method corresponding to the selected coded pattern from among a plurality of deconvolution methods respectively corresponding to the plurality of coded patterns.

2. The imaging method of claim 1, wherein each of the plurality of coded patterns have a different aperture degree.

3. The imaging method of claim 1, wherein the variable coded aperture filter is a liquid crystal (LC) optical filter.

4. The imaging method of claim 2, wherein the variable coded aperture filter is an LC optical shutter filter.

5. The imaging method of claim 1, wherein the variable coded aperture filter comprises a micromirror array including a plurality of movable mirrors.

6. The imaging method of claim 2, wherein the variable coded aperture filter comprises a micromirror array including a plurality of movable mirrors.

7. The imaging method of claim 1, wherein the variable coded aperture filter comprises a mechanical iris including a plurality of diaphragms.

8. The imaging method of claim 2, wherein the variable coded aperture filter comprises a mechanical iris including a plurality of diaphragms.

9. An imaging apparatus comprising:
a light receiving device;
a lens device disposed in an optical path of a light proceeding toward the light receiving device;
a variable coded aperture filter controlling the light incident onto the light receiving device and modulating the light using a plurality of coded patterns; and
an image processor having deconvolution logic structures corresponding to each of the coded patterns of the variable coded aperture filter for performing a deconvolution of an image output from the light receiving device.

10. The imaging apparatus of claim 9, wherein each of the plurality of coded patterns have a different aperture degree.

11. The imaging apparatus of claim 9, wherein the variable coded aperture filter is an LC optical shutter filter.

12. The imaging apparatus of claim 10, wherein the variable coded aperture filter is an LC optical shutter filter.

13. The imaging apparatus of claim 9, wherein the variable coded aperture filter comprises a micromirror array including a plurality of movable mirrors.

14. The imaging apparatus of claim 10, wherein the variable coded aperture filter comprises a micromirror array including a plurality of movable mirrors.

15. The imaging apparatus of claim 9, wherein the variable coded aperture filter comprises a mechanical iris including a plurality of diaphragms.

16. The imaging apparatus of claim 10, wherein the variable coded aperture filter comprises a mechanical iris including a plurality of diaphragms.

17. An imaging apparatus comprising:
a variable coded aperture filter that filters a received light as the received light passes through the variable coded aperture filter;
a lens that focuses the received light filtered by the variable coded aperture filter; and
a light receiving device that receives the focused light.

18. The imaging apparatus of claim 17, wherein the received light is modified by a predetermined code when passing through the variable coded aperture filter.

19. The image apparatus of claim 17, wherein the variable coded aperture filter modulates the received light using at least one coded pattern.

20. The imaging apparatus of claim 19, further comprising an image processor that deconvolutes an image obtained from the light receiving device, wherein the deconvolution of the image is based on the at least one coded pattern.

21. The imaging apparatus of claim 17, wherein the variable coded aperture filter is sensitive to change in depth of field.

22. The imaging apparatus of claim 17, further comprising an image processor that obtains a convolution image based on a convolution image signal obtained from the light receiving device.

23. The imaging apparatus of claim 22, wherein the convolution image signal is deblurred based on depth information and focus information of the convolution image.
